(19) United States
(12) Patent Application Publication
(10) Pub. No.: US 2026/0323712 A1
(43) Pub. Date: Oct. 15, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Xuan MA, Shenzhen (CN); Mengzhu CHEN, Shenzhen (CN); Bo DAI, Shenzhen (CN); Jun XU, Shenzhen (CN); Xiaoying MA, Shenzhen (CN); Qiujin GUO, Shenzhen (CN)

(21) Appl. No.: 19/485,212

(22) PCT Filed: Jun. 9, 2023
(86) PCT No.: PCT/CN2023/099439

§ 371 Date: Nov. 17, 2025

(51) Int. Cl. H04W 74/0833; H04L 27/26; H04W 74/00; H04W 74/04

(52) U.S. Cl. CPC H04W 74/0833; H04L 27/26025; H04W 74/006; H04W 74/04

(57) ABSTRACT

A wireless communication method is disclosed. The method comprises receiving, by a wireless communication terminal, a first signaling on a first cell from a wireless communication node, wherein the first signaling comprises system configuration information for a second cell, wherein the system configuration information comprises system information, SI, or random access information.

### TECHNICAL FIELD

This document is directed generally to wireless communications, and in particular to 5^{th} generation (5G) communications or 6^{th} generation (6G) communications.

### BACKGROUND

The transmission of System Information (SI) from the Base Station (BS) involves the broadcasting of essential network details and parameters to user devices. The BS periodically sends SI messages, including Cell Identity, scheduling information, network parameters, cell coverage configuration, mobility management procedures, paging information, system broadcast messages, and security information. These SI transmissions ensure that user equipments (UEs) can efficiently access and operate within the network, providing them with the necessary information for cell selection, handover, system updates, and overall network connectivity.

### SUMMARY

This document relates to methods, systems, and computer program products for a wireless communication.

One aspect of the present disclosure relates to a wireless communication method. In an embodiment, the wireless communication method includes: receiving, by a wireless communication terminal, a first signaling on a first cell from a wireless communication node, wherein the first signaling comprises system configuration information for a second cell, wherein the system configuration information comprises system information, SI, or random access information.

Another aspect of the present disclosure relates to a wireless communication method. In an embodiment, the wireless communication method includes: transmitting, by a wireless communication node to a wireless communication terminal, a first signaling on a first cell, wherein the first signaling comprises system configuration information for a second cell, wherein the system configuration information comprises system information, SI, or random access information.

Another aspect of the present disclosure relates to a wireless communication terminal. In an embodiment, the wireless communication terminal includes a communication unit and a processor. The processor is configured to: receive, via the communication unit, a first signaling on a first cell from a wireless communication node, wherein the first signaling comprises system configuration information for a second cell, wherein the system configuration information comprises system information, SI, or random access information.

Another aspect of the present disclosure relates to a wireless communication node. In an embodiment, the wireless communication node includes a communication unit and a processor. The processor is configured to: transmit, via the communication unit to a wireless communication terminal, a first signaling on a first cell, wherein the first signaling comprises system configuration information for a second cell, wherein the system configuration information comprises system information, SI, or random access information.

Various embodiments may preferably implement the following features:

Preferably, the first signaling further comprises at least one of:
a downlink control information, DCI, scheduling a system information block, SIB, for the second cell;
an SI change indication for the second cell;
a DCI scheduling an SIB for the first cell;
SI for the first cell; or
an SI change indication for the first cell;
wherein the first cell associates with one or more second cells.

Preferably, the SI for the second cell and SI for the first cell satisfies at least one of:
the SI for the second cell and the SI for the first cell are transmitted through time division multiplexing, TDM;
the SI for the second cell and the SI for the first cell are transmitted through frequency division multiplexing, FDM;
the SI for the second cell and the SI for the first cell are carried by a same system information block, SIB; or
the SI for the second cell and the SI for the first cell are transmitted in a same Physical downlink shared channel, PDSCH.

Preferably, an SI occasion for the second cell is determined based on at least one of a reference time location, an offset, or a cell ID.

Preferably, the reference time location comprises at least one of: a system frame number, SFN, of the SI occasion for the first cell, a slot index of the SI occasion for the first cell, or a symbol index of the SI occasion for the first cell.

Preferably, the SI occasion comprises at least one of a set of physical downlink control channel, PDCCH, monitoring occasions for scheduling the SI or a set of occasions for an SI transmission.

Preferably, the offset is determined by at least one of: a cell index of the second cell, a cell ID of the second cell, a pre-defined value, or an indication indicating the offset.

Preferably, slot indexes of monitoring occasions of PDCCH scheduling an SI for the second cell is determined by satisfying

$${n}_{0} = ( O \cdot {2}^{μ} + ⌊ i \cdot M ⌋ ) mod {N}_{slot}^{frame , μ} + offset ,$$

μ is one or more of a set {0, 1, 2, 3, 5, 6} and is determined based on the Subcarrier Spacing, SCS, for PDCCH receptions in a Control Resource Set, CORESET, i is a synchronization signal physical broadcast channel, SS/PBCH, block index that the SI for the first cell corresponds to,

$${N}_{slot}^{frame , μ}$$

is a number of slots in one frame in the second cell, and M and O are pre-determined values.

Preferably, frequency resources for an SI for the second cell is determined by at least one of: a reference frequency resource, an offset, or a cell ID.

Preferably, the reference frequency resource comprises at least one of: a minimum resource block, RB, index of an SI for the first cell, a middle RB index of an SI for the first cell, a maximum RB index of an SI for the first cell, a minimum RB index of a Synchronization Signal/Physical Broadcast Channel Block, SSB, for the first cell, a middle RB index of an SSB for the first cell, or a maximum RB index of an SSB for the first cell.

Preferably, the offset is determined by at least one of: a cell index of the second cell, a cell ID of the second cell, a pre-defined value, or an indication indicating the offset.

Preferably, the frequency resources for the SI for the second cell is indicated by Downlink Control Information, DCI, scheduling the SI for the second cell.

Preferably, a monitoring occasion for an SI for the second cell is in an SI window.

Preferably, the SI window is determined by at least one of: a start point, an end point, a duration, or a cycle.

Preferably, the wireless communication terminal performs at least one of:
monitoring a PDCCH scheduling the SI for the second cell in the SI window; or
stop monitoring a PDCCH scheduling the SI for the second cell until the end of the SI window or in response to an SI message being detected.

Preferably, both frequency domain resource and time domain resource of an SI for the second cell is the same as both frequency domain resource and time domain resource of an SI for the first cell.

Preferably, DCI scheduling an SI for the second cell is a DCI with a CRC scrambled by a specific Radio Network Temporary Identifier, RNTI.

Preferably, the specific RNTI satisfies at least one of:
the specific RNTI is pre-defined;
the specific RNTI is configured with one or more RNTI values;
a range of an RNTI value of the specific RNTI is from a value FFF3 to a value FFFB;
the specific RNTI is an SI-RNTI; or
the specific RNTI is associated with a cell ID or cell indicator,
wherein one specific RNTI associates with one or more second cells.

Preferably, DCI scheduling an SI for the second cell is a DCI format 1_0 with a CRC scrambled by a System Information RNTI, SI-RNTI, wherein a bit field in the DCI is used to indicate a target cell of the SI scheduled for.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a schematic diagram of a wireless communication terminal according to an embodiment of the present disclosure.

FIG. 2 shows an example of a schematic diagram of a wireless communication node according to an embodiment of the present disclosure.

FIGS. 3 and 4 show flowcharts of wireless communication methods according to some embodiments of the present disclosure.

### DETAILED DESCRIPTION

In some embodiments of the present disclosure, the periodical transmission of Synchronization Signal/Physical Broadcast Channel Blocks (SSB) and System Information Blocks (SIB) may reduce network sleep opportunities and increase network power consumption, especially in the case of low or empty load. In some embodiments of the present disclosure, to achieve network energy saving, Downlink (DL) common signal/channel reduction, for example, not transmitting SSB and/or SIB in a specific cell (e.g. a network energy-saving (NES) cell), may be adopted. However, when no SIB is transmitted on the specific cell, the User Equipment (UE) may not be able to obtain the system information for the specific cell. Some embodiments of the present disclosure allow the UE to obtain the System Information (SI) for the specific cell.

In some embodiments, UE receives a first signaling on a first cell, wherein the first signaling comprises at least one of system configuration information for a second cell (e.g., a NES cell), wherein the system configuration information comprises system information, SI, or random access information; a downlink control information, DCI, scheduling a system information block, SIB, for a second cell; an SI change indication for the second cell; a DCI scheduling a SIB for a first cell; an SI for a first cell; or an SI change indication for a first cell. In some embodiments, a first cell may associate with one or more second cells (e.g., NES cells).

In some embodiments, the UE may receive, from a base station (BS), at least one of:
configuration information;
DCI scheduling an SIB for a second cell on a first cell;
SI for the second cell on the first cell; or
an SI change indication for the second cell.

In some embodiments, the second cell comprises at least one of a pre-determined cell for the UE or a pre-determined carrier for the UE.

In some embodiments, the first cell is an anchor cell. In some embodiments, the second cell is a network energy saving, NES, cell.

In some embodiments, the SI or the SIB for the first cell refers to the SI or the information in the SIB for the UE in the first cell. In some embodiments, the SI or the SIB for the second cell refers to the SI or the information in the SIB for the UE in the first cell.

In some embodiments, the first cell is an SpCell (special cell) (i.e., a PCell (primary cell) or a PSCell (Primary Secondary Cell)), a predetermined cell, a carrier, a special cell, an active cell, a non-dormancy cell, or a cell including at least one of an active DL BWP or an active UL BWP.

In some embodiments, the second cell is a non-anchor cell, a SCell, a dormancy cell, a cell supporting at least one of an energy saving operation, or a cell supporting at least one of the UE to perform one or more energy saving operations. Wherein the energy saving operation comprises at least one of no SSB transmitted, no SIB transmitted, no paging transmitted, or with simplified SSB transmitted.

In some embodiments, each first cell can associate with one or more second cells. the association of the first cell and the second cell comprises at least one of: the SI for the second cell are transmitted in the first cell, the RACH information for the second cell are transmitted in the first cell, the synchronization information of the second cell are acquired from the first cell.

In some embodiments, the SI refers to the SI carried by SIB1. For example, the SIB1 for the second cell is transmitted on the first cell and the OSIs for the second cell are transmitted on the second cell. In some other embodiments, the SI refers to the SI carried by both the SIB1 and the SIBs other than SIB1 (OSI). For example, both the SIB1 for the second cell and OSIs for the second cell are transmitted on the first cell. In some other embodiments, the SI refers to the SI carried by the SIB1 and part of the OSI. For example, the SIB1 for the second cell is transmitted on the first cell, part of the OSIs for the second cell are transmitted on the first cell, and part of the OSIs for the second cell are transmitted on the second cell wherein the OSIs for the second cell transmitted on the first cell or transmitted in the second cell are determined by the high layer configuration or pre-determined. In some other embodiments, the SI refers to the SI carried by the OSI.

In some embodiments, the UE may further receive, from at least one of a base station (BS) on the first cell, at least one of:
DCI scheduling a system information block (SIB) for a first cell;
SI for a first cell; or
SI change indication for the first cell.

In some embodiments, the first cell is an SpCell (special cell) (i.e., a PCell (primary cell) or a PSCell (Primary Secondary Cell)), a predetermined cell, or a carrier. Each first cell can associate with one or more second cells.

Many aspects of embodiments of the present disclosure are described in the paragraphs below, but the present disclosure is not limited thereto.

### Aspects 1: Configuration Information

In some embodiments, the configuration information received by the UE comprises one or more configurations for at least one of a second cell, a first cell or an SCell (secondary cell) for an idle/inactive mode UE.

In some embodiments, the configuration of the SCell includes one or more configurations for an idle/inactive mode UE. In some embodiments, whether the UE supports carrier aggregation is determined by the UE capability.

In some embodiments, the configuration information comprises at least one of SI, random access information for the first cell, random access information for the second cell, the SCell configuration, the multi-carrier configuration, the cell ID of the first cell, the cell ID of the second cell, the association between the first cell and the second cell.

In some embodiments, the configuration includes at least one of: the cell ID of the first cell, the cell ID of the second cell associated with the first cell, the cell specific configuration information (such as the paging related information, the SIB related information, etc.), the information of whether to support associated second cell (e.g., an indication (e.g., with one bit) to indicate whether the second cell is supported), or the frequency information for the second cell (e.g., the frequency range).

### Aspects 2: Transmission of SI for Second Cell

The SI is carried by a SIB. In some embodiments, the SI for the second cell and the SI for the first cell are transmitted in the same SIB. In some other embodiments, the SI for the second cell and the SI for the first cell are transmitted in the different SIBs.

In some embodiments, the transmission of the SI for the second cell and the SI for the first cell satisfies at least one of: the SI for the second cell and the SI for the first cell are transmitted through time division multiplexing, TDM; the SI for the second cell and the SI for the first cell are transmitted through frequency division multiplexing, FDM; the SI for the second cell and the SI for the first cell are transmitted in the same SIB; or the SI for the second cell and the SI for the first cell are transmitted in the same Physical downlink shared channel, PDSCH.

In some embodiments, whether the SI for the second cell and the SI for the first cell are transmitted in the same PDSCH or in the different PDSCH is determined by scheduling information or configured by the SIB1.

### Aspects 3: NES SIB Monitoring Occasions

In some embodiments, the SI occasions for a second cell are associated with at least one of: a reference time location, an offset, or a cell ID. The SI occasion includes at least one of: a set of physical downlink control channel, PDCCH, monitoring occasions for scheduling the SI or a set of occasions for SI transmission.

In some embodiments, the SI occasions comprise the time domain resource of the SI or the SIB carrying the SI. In some embodiments, the location of the SIB carrying the SI comprises the SI occasion. In some examples, the SIB carrying the SI for the first cell is also referred to as the SIB for the first cell, the SIB carrying the SI for the second cell is also referred to as the SIB for the second cell.

In some embodiments, the reference time location comprises at least one of: a system frame number, SFN, associated with an SI occasion for the first cell, a slot index associated with an SI occasion for the first cell, or a symbol index associated with an SI occasion for the first cell. The SI occasions includes at least one of: a set of physical downlink control channel, PDCCH, monitoring occasions for scheduling the SI or a set of occasions for SI transmission.

In some embodiments, the reference time location includes at least one of: a system frame number (SFN) of the SI occasion for the first cell, a slot index of the SI occasion for the first cell, or a symbol index of the SI occasion for the first cell.

In some embodiments, the offset is determined by at least one of: a cell index of the second cell, a cell ID of the second cell, a pre-defined value, or an indication indicating the offset.

In some examples, the offset is determined by a pre-determined value, which is configured by the RRC parameter. In some other examples, the offset is determined by a cell index or a cell ID. The offset can be determined by offset=A+B*(ID-1), wherein the A and B are non-negative values, and the ID is the cell index or the cell ID of the second cell.

In some embodiments, the SFN of the SI occasion for the second cell is determined by the SFN of the SI occasion for the first cell and an offset, wherein the offset is a frame level offset. In some embodiments, the slot index and the symbol index of the SI occasion for the second cell are equal to the slot index and the symbol index of the SI occasion for the first cell.

In some examples, the offset is a non-negative value, the location of the SIB carrying the SI for the second cell (e.g. the SIB for the second cell) and the SIB carrying the SI for the first cell (e.g. the SIB for the first cell) is predetermined. For example, in the case that it is predetermined that the SIB for the second cell is transmitted after the SIB for the first cell, the SFN of the SIB for the second cell is equal to the SFN of the SIB for the first cell plus the offset (SFN_NESSIB=SFN_anchorSIB+offset). In the case that it is predetermined that the SIB for the second cell is transmitted before the SIB for the first cell, the SFN of the SIB for the second cell is equal to the SFN of the SIB for the first cell minus the offset (SFN_NESSIB=SFN_anchorSIB−offset).

In some examples, the offset is an integer, and the SFN of the SIB for the second cell is equal to the SFN of the SIB for the first cell plus the offset (SFN_NESSIB=SFN_anchorSIB+offset). When the offset is a negative value, the SIB for the second cell is transmitted before the SIB for the first cell. When the offset is a non-negative value, the SIB for the second cell is transmitted after the SIB for the first cell.

In some embodiments, the slot index of the NES SIB monitoring occasion is determined by the slot index of the SIB for the first cell and an offset, wherein the offset is a slot level offset. In some embodiments, the SFN and the symbol index of the SIB carrying the SI for the second cell are equal to the SFN and the symbol index of the SIB carrying the SI for the first cell respectively.

In some examples, the offset is a non-negative value, the location of the SIB for the second cell and the SIB for the first cell is predetermined. For example, it is predetermined that the SIB for the second cell is transmitted after the SIB for the first cell, and the slot index of the SIB for the second cell is equal to the slot index of the SIB for the first cell plus the offset (SlotIndex_NESSIB=SlotIndex_anchorSIB+offset). As another example, it is predetermined that the SIB for the second cell is transmitted before the SIB for the first cell, and the slot index of the SIB for the second cell is equal to the slot index of the SIB for the first cell minus the offset (SlotIndex_NESSIB=SlotIndex_anchorSIB−offset).

In some examples, the offset is an integer, and the slot index of the SIB for the second cell is equal to the slot index of the SIB for the first cell plus the offset (SlotIndex_NESSIB=SlotIndex_anchorSIB+offset). When the offset is a negative value, the SIB for the second cell is transmitted before the SIB for the first cell, when the offset is a non-negative value, the SIB for the second cell is transmitted after the SIB for the first cell.

In some embodiments, the symbol index of the SI occasion is determined by the symbol index of the SI occasion for the first cell and an offset, wherein the offset is a symbol level offset. In some embodiments, the SFN and the slot index of the SIB for the second cell are equal to the SFN and the slot index of the SIB for the first cell.

In some examples, the offset is a non-negative value, the location of the SIB for the second cell and the SIB for the first cell is predetermined. For example, it is predetermined that the SIB for the second cell is transmitted after the SIB for the first cell, and the symbol index of the SIB for the second cell is equal to the symbol index of the SIB for the first cell plus the offset (SymbIndex_NESSIB=SymbIndex_anchorSIB+offset). As another example, it is predetermined that the SIB for the second cell is transmitted before the SIB for the first cell, then the symbol index of the SIB for the second cell is equal to the symbol index of the SIB for the first cell minus the offset (SymbIndex_NESSIB=SymbIndex_anchorSIB−offset).

In some examples, the offset is an integer, and the symbol index of the SIB for the second cell is equal to the symbol index of the SIB for the first cell plus the offset (SymbIndex_NESSIB=SymbIndex_anchorSIB+offset). When the offset is a negative value, the SIB for the second cell is transmitted before the SIB for the first cell, when the offset is a non-negative value, the SIB for the second cell is transmitted after the SIB for the first cell.

In some embodiments, both the SFN and the slot index of the NES SIB monitoring occasion are equal to the SFN and the slot index of the SIB for the first cell plus an offset, and the symbol index of the SIB for the second cell are equal to the symbol index of the SIB for the first cell.

In some embodiments, both the slot index and the symbol index of the NES SIB monitoring occasion are equal to the slot index and the symbol index of the SIB for the first cell plus an offset, and the SFN of the SIB for the second cell are equal to the SFN of the SIB for the first cell.

In some embodiments, the SFN, the slot index and the symbol index of the NES SIB monitoring occasion are equal to the SFN, the slot index and the symbol index of the SIB for the first cell plus an offset, respectively. For example, the SFN of the NES SIB monitoring occasion is equal to the SFN of the SIB for the first cell plus an offset, the slot index of the NES SIB monitoring occasion is equal to the slot index of the SIB for the first cell plus an offset, and the symbol index of the NES SIB monitoring occasion is equal to the symbol index of the SIB for the first cell plus an offset.

In some embodiments, one or more of the SFN, slot index, symbol index of the PDCCH monitoring occasion for the second cell SIB, and the NES SIB monitoring occasion are respectively equal to one or more of the SFN, slot index, symbol index of the PDCCH monitoring occasion for the SIB for the first cell, or the monitoring occasion for the SIB for the first cell.

In some embodiments, the SIB for the second cell is associated with the SIB for the first cell. In some embodiments, the association between the SIB for the second cell is associated with the SIB for the first cell may indicate at least one of: the SIB for the second cell is associated with the SIB for the first cell have a same SIB index, the SIB for the second cell is associated with the SIB for the first cell have the same SSB index corresponding to the SIBs, or the SIB for the second cell is associated with the SIB for the first cell have the same reference signal. In some embodiments, the reference signal can provide the QCL (Quasi Co-Location) information for the SIB.

In some embodiments, the SFN of the SIB monitoring occasion for the second cell (e.g., the NES SIB monitoring occasion) is determined by a first condition, wherein the first condition is associated with the SFN of the SIB monitoring occasion for the first cell.

In some examples, the first condition is the SFN of the SIB monitoring occasion for the first cell is an odd number, and that is, the SFN of the SIB monitoring occasion for the first cell (i.e., SFN_anchor) satisfies SFN_anchor mod 2=1. When the first condition is met, the SFN of the SIB monitoring occasion for the second cell is an odd number, otherwise, the SFN of the SIB monitoring occasion for the second cell is an even number.

In some other examples, the first condition is the SFN of the SIB monitoring occasion for the first cell is an even number, and that is, the SFN of the SIB monitoring occasion for the first cell satisfying SFN_anchor mod 2=0. When the first condition is met, the SFN of the SIB monitoring occasion for the second cell is an odd number, otherwise, the SFN of the SIB monitoring occasion for the second cell is an even number.

In some embodiments, the slot index of the NES SIB monitoring occasion is determined by a formula satisfying

$${n}_{0} = ( O \cdot {2}^{μ} + ⌊ i \cdot M ⌋ ) mod {N}_{slot}^{frame , μ} + offset ,$$

wherein the NES SIB monitoring occasion includes at least one of a set of PDCCH monitoring occasions wherein the PDCCH schedules a SIB for second cell (the DCCH monitoring occasions includes at least one of a Type0-PDCCH monitoring occasion, a new type PDCCH monitoring occasion), a set of monitoring occasions of the SIB for the second cell; μ∈{0, 1, 2, 3, 5, 6} based on the SCS (Subcarrier Spacing) for PDCCH receptions in the CORESET, i is the SS/PBCH (synchronization signal physical broadcast channel) block index that the SI for the first cell or SI for the second cell corresponds to,

$${N}_{slot}^{frame , μ}$$

is the number of slots in one frame that the SIB belongs to.

For μ∈{0, 1, 2, 3} and for an SS/PBCH block index i, the two slots where the associated SIB monitoring occasions located at are slots n_0 and n_0+1. M, O, and the index of the first symbol of the CORESET in slots n_0 and n_0+1 are pre-determined values.

For μ=5 and for a SS/PBCH block index i, the two slots where the associated SIB monitoring occasions located at are slots n_0 and n_0+4. M, O, and the index of the first symbol of the CORESET in slots n_0 and n_0+4 are pre-determined values.

For μ=6 and for a SS/PBCH block index i, the two slots where the associated SIB monitoring occasions located at are slots n_0 and n_0+8. M, O, and the index of the first symbol of the CORESET in slots n_0 and n_0+8 are pre-determined values.

### Aspects 4: Frequency Resources

In some embodiments, the frequency resources of the SIB for the second cell are associated with at least one of a reference frequency resource, an offset, or a cell ID.

In some embodiments, the reference frequency resource comprises at least one of: the minimum RB (resource block) index of the SIB for the first cell, the middle RB index of the SIB for the first cell (e.g., the middle RB index=ceil((the minimum RB+the maximum RB index)/2), the maximum RB index of the SIB for the first cell, the minimum RB index of the SSB for the first cell, the middle RB index (e.g., the middle RB index=ceil ((the minimum RB+the maximum RB index)/2) of the SSB for the first cell, or the maximum RB index of the SSB for the first cell.

In some embodiments, the offset is determined by at least one of: a cell index of the second cell, a cell ID of the second cell, or a pre-defined value. In some examples, the offset is determined by a pre-determined value, which is configured by the RRC parameter. In some other examples, the offset is determined by a cell index or a cell ID. The offset can be determined by offset=A+B*(ID-1), wherein the A and B are non-negative values, and the ID is the cell index or the cell ID of the second cell.

In some embodiments, the RB index of the SIB for the second cell is equal to the reference frequency resource plus an offset, that is RBIndex_NES=reference frequency resource +offset. In some examples, the offset is an integer, when the offset is a negative value, the SIB for the second cell is transmitted at a frequency band lower than the frequency band of the SIB for the first cell, when the offset is a non-negative value, the SIB for the second cell is transmitted at a frequency band higher than the frequency band of the SIB for the first cell.

In some embodiments, the frequency resources of the SIB for the second cell are indicated by a first DCI that schedules the SIB for the second cell. In some embodiments, the first DCI is DCI format 1_0 with the CRC scrambled by the SI-RNTI (System Information RNTI (Radio Network Temporary Identifier)). In some embodiments, the DCI is DCI format 1_0 with the CRC scrambled by a new RNTI, e.g., a NES-RNTI.

### Aspects 5: SI Window

In some embodiments, the SIB monitoring occasions for the second cell are in an SI window, wherein the SIB monitoring occasion for the second cell includes at least one of: the PDCCH monitoring occasion for scheduling the SIB for the second cell and/or the monitoring occasion of the SIB for the second cell. The SI window is a time period where the UE monitors the PDCCH that schedules an SIB. In some embodiments, each second cell associated with one SI window.

In some embodiments, the SI window is determined by at least one of: a start point, an end point, a duration (e.g., the length of the SI window), or a cycle. In some examples, the SI window is determined by a start point, a duration and a cycle. In some other examples, the SI window is determined by a start point, an end point and a cycle.

In some embodiments, at least one of the SFN of the start point or the SFN of the end point is determined by (SFN+offset) mod T=floor (x/N), wherein the offset is configured by the high layer parameter, T is the cycle of the SI window, Nis the number of the slots in one frame, and x is associated with the cell index of the second cell. For example, x=(ID-1)*L, wherein the ID is the cell index of the second cell, and L is the length of the SI window.

In some embodiments, at least one of the slot index of the start point or the slot index of the end point is determined by s=(x+offset) mod N, wherein the offset is configured by the high layer parameter, N is the number of the slots in one frame, and x is associated with the cell index of the second cell. For example, x=(ID-1)*L, wherein the ID is the cell index of the second cell, and L is the length of the SI window.

In some embodiments, the UE monitors the PDCCH that schedules an SIB for the second cell in the SI window from the start of the SI window and continue until the end of the SI-window or until the SI was received. If the SI was not received by the end of the SI window, the UE may repeat that of the reception for the PDCCH that schedules an SIB at the next SI-window occasion for the second cell.

In some embodiments, the SI window for the second cell occurs periodically, the UE monitors the PDCCH that schedules an SIB for the second cell in each SI window. In some other embodiments, the SI window for the second cell occurs periodically, the UE monitors the PDCCH that schedules an SIB for the second cell in the SI window only when needed. In some embodiments, the SI window occurs on-demand, the UE monitors the PDCCH that schedules an SIB for the second cell in the SI window only when needed.

### Aspects 6: Transmission of SI for Second Cell

In some embodiments, the SI for the second cell and the SI for the first cell are carried in one SIB. In some embodiments, the SI for the second cell is attached to the SI for the first cell and transmitted in the same SIB.

### Aspects 7: Frequency Domain Resource and the Time Domain Resource of SIB for Second Cell

In some embodiments, both the frequency domain resource and the time domain resource of the SIB for the second cell are the same as the frequency domain resource and the time domain resource of the SIB for the first cell. In some embodiments, the SIB for the second cell and the SIB for the first cell are not transmitted at the same time. The UE may determine whether the received SIB is for the second cell or for the first cell according to the information carried by the scheduling DCIs.

### Aspects 8: Frequency Resource of CORESET

In some embodiments, the frequency resources of the CORESET of the DCI scheduling an SIB for the second cell are associated with at least one of a reference frequency resource, an offset, or a cell ID.

In some embodiments, the reference frequency resource comprises at least one of the minimum RB index of the CORESET 0, the middle RB index (e.g., the middle RB index=ceil ((the minimum RB+the maximum RB index)/2) of the CORESET 0, or the maximum RB index of the CORESET 0. in some embodiments, the CORESET 0 is the CORESET 0 in the first cell.

The offset is determined by at least one of a cell index of the second cell, a cell ID of the second cell, or a pre-defined value. In some examples, the offset is determined by a pre-determined value, which is configured by the RRC parameter. In some other examples, the offset is determined by a cell index or a cell ID. The offset can be determined by offset=A+B*(ID-1), wherein A and B are non-negative values, and the ID is the cell index or the cell ID of the second cell.

In some embodiments, the RB index of the CORESET of the DCI scheduling an SIB for the second cell is equal to the reference frequency resource plus an offset.

In some embodiments, the first signaling comprise a DCI, wherein the DCI comprises at least one of a cell ID or cell index indicator.

In some embodiments, the first signaling comprise a PDSCH, wherein the PDSCH comprises at least one of a cell ID or cell index indicator.

### Aspects 9: Scheduling DCI.

In some embodiments, the DCI scheduling an SIB for the second cell is DCI with the CRC scrambled by a specific RNTI. In some embodiments, the DCI is DCI format 1_0.

In some embodiments, the DCI scheduling an SIB is a DCI format 1_0 with CRC scrambled by a System Information RNTI, SI-RNTI, wherein a bit field in the DCI is used to indicate a target cell of the SI scheduled for. The target cell can be a first cell or a second cell.

In some embodiments, the specific RNTI is pre-defined. For example, the specific RNTI is a NES-RNTI with one or more RNTI values. In some embodiments, the range of the specific RNTI value can be from value FFF3 to value FFFB.

In some embodiments, one RNTI value is configured for the specific RNTI.

In some cases, the SIBs for different second cells are scheduled by the DCI with the CRC scrambled by the specific RNTI with the same RNTI value.

In some cases, one RNTI value is configured for the specific RNTI. For different second cells (e.g. multiple second cells are associated with one first cell), different RNTI values are used to scramble the CRC of the scheduling DCI, and the RNTI value is determined by the configured RNTI value plus a delta value.

In some embodiments, the RNTI value is associated with at least one of: a cell ID or a cell index of the second cell, or a cell ID or a cell index of the first cell. For example, the delta value is equal to the cell ID of the second cell. For another example, the delta is equal to the difference between the cell ID of the first cell and the cell ID of the second cell.

In some embodiments, one RNTI value is configured for the specific RNTI. A bit field in the DCI with CRC scrambled by the specific RNTI is used to indicate the target second cell of the SIB scheduled for.

In some embodiments, more than one RNTI values are configured for the specific RNTI, and each second cell associated with one specific RNTI value. In some embodiments, the different RNTI values are fixed values. In some embodiments, the RNTI for different second cell are broadcast by the SIB for the first cell.

In some embodiments, the specific RNTI is the SI-RNTI. The scheduling information (e.g., an indication that the scheduled SIB is for the first cell or the second cell) is transmitted by DCI with the DCI format 1_0 and with the CRC scrambled by the SI-RNTI.

In some embodiments, the DCI format 1_0 and with the CRC scrambled by the SI-RNTI is used to schedule a SIB for second cell or used to schedule a SIB for first cell is determined by at least one of: the size of the DCI format 1_0 and with the CRC scrambled by the SI-RNTI, the bit value of a bit field in the DCI format 1_0 with the CRC scrambled by the SI-RNTI.

In some embodiments, the size of the DCI scheduling a SIB for second cell is larger than that of the DCI scheduling a SIB for first cell.

In some embodiments, a bit field in the DCI format 1_0 with the CRC scrambled by the SI-RNTI is a cell ID field used to indicate the cell ID of the second cell.

In some embodiments, a bit field in the DCI format 1_0 with the CRC scrambled by the SI-RNTI is a flag field to indicate the target cell is a second cell or a first cell.

In some embodiments, a bit field in the DCI format 1_0 with the CRC scrambled by the SI-RNTI is in a form of bitmap, each bit in the bit field corresponds to one second cell.

In some embodiments, a bit field in the DCI format 1_0 with the CRC scrambled by the SI-RNTI indicates the type of the SIB to be transmitted.

In some embodiments, a bit field in the DCI format 1_0 with the CRC scrambled by the SI-RNTI indicates the cell index which the SIB scheduled for.

In some embodiments, a specific search space is configured for the DCI scheduling the SIB for a second cell.

In some embodiments, a certain bit field in the DCI format 1_0 with the CRC scrambled by the SI-RNTI is used to indicate the target cell, wherein the target cell is the SIB scheduled by the DCI format 1_0 with the CRC scrambled by the SI-RNTI belonging to. The target cell comprises at least one of a first cell, a second cell.

In some embodiments, said certain bit field comprises one bit. In some embodiments, the bit is ‘1’ to indicate the SIB scheduled by the DCI is for the first cell, the bit is ‘0’ to indicate the SIB scheduled by the DCI is for the second cell. In some other embodiments, the bit is ‘0’ to indicate the SIB scheduled by the DCI is for the first cell, the bit is ‘1’ to indicate the SIB scheduled by the DCI is for the second cell.

In some other embodiments, said certain bit field comprises more than one bit. In some embodiments, the bits in said certain bit field are indicate a cell ID. When the cell ID corresponds to a first cell, the SIB scheduled by the DCI is for the first cell, when the cell ID corresponds to a second cell, the SIB scheduled by the DCI is for the second cell. In some embodiments, when said certain bit field is all zeros, the scheduled SIB is for the first cell. In some embodiments, when said certain bit field is all zeros, the scheduled SIB is for the second cell.

In some other embodiments, said certain bit field comprises more than one bit. In some embodiments, the bits in said certain bit field is in a form of bitmap. Each bit in said certain bit field corresponds to one pre-determined cell, wherein the pre-determined cell is the first cell or the second cell associated with the first cell. For example, there is a first cell, and two second cells are associated with the first cell. In some embodiments, the first bit in said certain bit field corresponds to the first cell, the second bit and the third bit in said certain bit field corresponds to the two second cells respectively (for example, the second bit corresponds to the second cell with the smaller cell ID, and the third bit corresponds to the second cell with the larger cell ID). In some embodiments, the bit is ‘1’ to indicate the SIB scheduled by the DCI is for the corresponding cell, the bit is ‘0’ to indicate the SIB scheduled by the DCI is not for the corresponding cell. In some embodiments, the bit is ‘0’ to indicate the SIB scheduled by the DCI is for the corresponding cell, the bit is ‘1’ to indicate the SIB scheduled by the DCI is not for the corresponding cell.

### Aspects 10: SI Change Information

In some embodiments, the UE may detect the SI change information for the second cell in the second cell (e.g., receive the SI change information for the second cell from the BS serving the second cell). The UE may receive the paging DCI in the second cell to obtain the SI change information.

In some other embodiments, the UE may detect the SI change information for the second cell in the first cell (e.g., receive the SI change information for the second cell from the BS serving the first cell).

In some embodiments, the UE detects the SI change information for the second cell in the first cell during the detection duration or window when the detection duration or window is effective. In some examples, the UE detects the paging DCI once in the detection duration or window. In some other embodiments, the UE detects the paging DCI in all paging occasions in the detection duration or window.

In some embodiments, the detection duration or window is determined by at least one of a start point, an end point, a duration (the length of the detection duration or window), or a cycle.

In some embodiments, at least one detection duration or window is within one SI change modification period.

In some embodiments, the SI change modification period is an integral multiple of the length of the detection duration or window.

In some embodiments, the SI change modification period is an integral multiple of the cycle of the detection duration or window.

In some embodiments, the detection duration or window includes one or more paging cycles.

In some embodiments, the UE monitors the DCI to acquire the SI change information for the second cell in the first cell. In some embodiments, the DCI includes a bit field to indicate whether the SI change information is for second cell or for first cell.

In the paragraphs below, details will be described along with some examples, but the present disclosure is not limited to the example below.

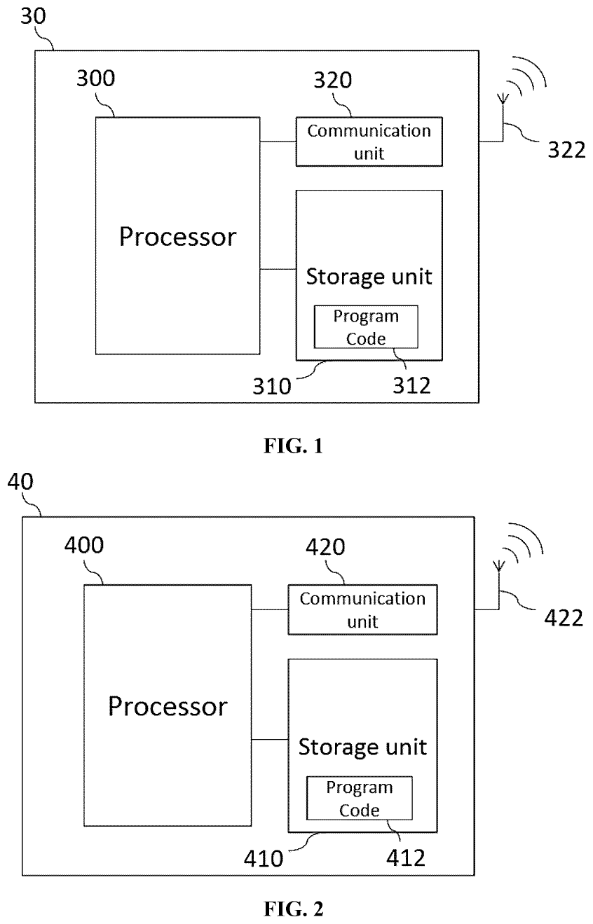

FIG. 1 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described in this disclosure. In some embodiments, the processor 300 and the communication unit 320 collaboratively perform the operations described in this disclosure. For example, the processor 300 performs operations and transmit or receive signals, message, and/or information through the communication unit 320.

FIG. 2 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the BS serving the second cell or the BS serving the first cell described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the UE described in this disclosure. In some embodiments, the processor 400 and the communication unit 420 collaboratively perform the operations described in this disclosure. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described in this disclosure, but is not limited thereto.

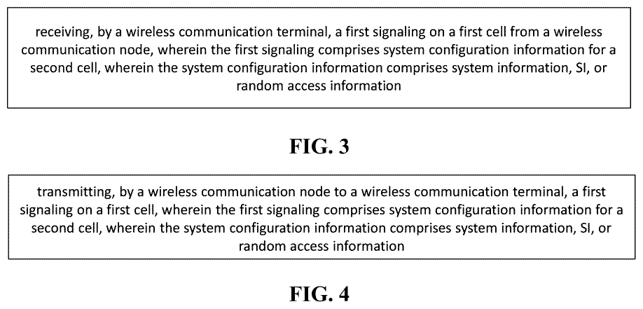

Referring to FIG. 3, in an embodiment, the wireless communication method includes: receiving, by a wireless communication terminal, a first signaling on a first cell from a wireless communication node, wherein the first signaling comprises system configuration information for a second cell, wherein the system configuration information comprises system information, SI, or random access information.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a BS). In an embodiment, the wireless communication node may be implemented by using the wireless communication node 40 described in this disclosure, but is not limited thereto.

Referring to FIG. 4, in an embodiment, the wireless communication method includes transmitting, by a wireless communication node to a wireless communication terminal, a first signaling on a first cell, wherein the first signaling comprises system configuration information for a second cell, wherein the system configuration information comprises system information, SI, or random access information.

Details in this regard can be ascertained with reference to the paragraphs above, and will not be repeated herein.

In some embodiments, the wireless communication terminal used in the present disclosure may indicate the UE described above.

In some embodiments, the wireless communication node used in the present disclosure may indicate the BS serving the second cell or the BS serving the first cell described above. In some embodiments, the first cell and the second cell are different.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is understood that, in the present disclosure, the term “and/or” or symbol may include any and all combinations of one or more of the associated listed items. For example, A and/or B and/or C includes any and all combinations of one or more of A, B, and C, including A, B, C, A and B, A and C, B and C, and a combination of A and B and C.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal, a first signaling on a first cell from a wireless communication node, or transmitting, by a wireless communication node to a wireless communication terminal, a first signaling on a first cell, wherein the first signaling comprises system configuration information for a second cell, and wherein the system configuration information comprises system information (SI) or random access information.

2. The wireless communication method of claim 1, wherein the first signaling further comprises at least one of:
a downlink control information (DCI) scheduling a system information block (SIB) for the second cell;
an SI change indication for the second cell;
a DCI scheduling an SIB for the first cell;
SI for the first cell; or
an SI change indication for the first cell;
wherein the first cell associates with one or more second cells.

3. The wireless communication method of claim 1, wherein the SI for the second cell and SI for the first cell satisfies at least one of:
the SI for the second cell and the SI for the first cell are transmitted through time division multiplexing (TDM);
the SI for the second cell and the SI for the first cell are transmitted through frequency division multiplexing (FDM);
the SI for the second cell and the SI for the first cell are carried by a same system information block (SIB); or
the SI for the second cell and the SI for the first cell are transmitted in a same Physical downlink shared channel (PDSCH).

4. The wireless communication method of claim 1, wherein an SI occasion for the second cell is determined based on at least one of a reference time location, an offset, or a cell ID.

5. The wireless communication method of claim 4, wherein the reference time location comprises at least one of: a system frame number (SFN) of the SI occasion for the first cell, a slot index of the SI occasion for the first cell, or a symbol index of the SI occasion for the first cell.

6. The wireless communication method of claim 4, wherein the SI occasion comprises at least one of a set of physical downlink control channel (PDCCH) monitoring occasions for scheduling the SI or a set of occasions for the SI transmission.

7. The wireless communication method of claim 4, wherein the offset is determined by at least one of: a cell index of the second cell, a cell ID of the second cell, a pre-defined value, or an indication indicating the offset.

8. The wireless communication method of claim 4, wherein slot indexes of monitoring occasions of PDCCH scheduling an SI for the second cell is determined by satisfying
$${n}_{0} = ( O \cdot {2}^{μ} + ⌊ i \cdot M ⌋ ) mod {N}_{slot}^{frame , μ} + offset ,$$
μ is one or more of a set {0, 1, 2, 3, 5, 6} and is determined based on the Subcarrier Spacing, (SCS) for PDCCH receptions in a Control Resource Set (CORESET) i is a synchronization signal physical broadcast channel (SS/PBCH) block index that the SI for the first cell corresponds to,
$${N}_{slot}^{frame , μ}$$
is a number of slots in one frame in the second cell, and M and O are pre-determined values.

9. The wireless communication method of claim 1, wherein frequency resources for an SI for the second cell is determined by at least one of: a reference frequency resource, an offset, or a cell ID.

10. The wireless communication method of claim 9, wherein the reference frequency resource comprises at least one of: a minimum resource block (RB) index of an SI for the first cell, a middle RB index of an SI for the first cell, a maximum RB index of an SI for the first cell, a minimum RB index of an SS/PBCH block for the first cell, a middle RB index of an SSB for the first cell, or a maximum RB index of an SSB for the first cell.

11. The wireless communication method of claim 9, wherein the offset is determined by at least one of: a cell index of the second cell, a cell ID of the second cell, a pre-defined value, or an indication indicating the offset.

12. The wireless communication method of claim 9, wherein the frequency resources for the SI for the second cell is indicated by Downlink control information (DCI) scheduling the SI for the second cell.

13. The wireless communication method of claim 1, wherein a monitoring occasion for an SI for the second cell is in an SI window.

14. The wireless communication method of claim 13, wherein the SI window is determined by at least one of: a start point, an end point, a duration, or a cycle.

15. The wireless communication method of claim 13, wherein the wireless communication terminal performs at least one of:
monitoring a PDCCH scheduling the SI for the second cell in the SI window; or
stop monitoring a PDCCH scheduling the SI for the second cell until the end of the SI window or in response to an SI message being detected.

16. The wireless communication method of claim 1, wherein both frequency domain resource and time domain resource of an SI for the second cell is the same as both frequency domain resource and time domain resource of an SI for the first cell.

17. The wireless communication method of claim 1, wherein DCI scheduling an SI for the second cell is a DCI with a CRC scrambled by a specific Radio network temporary identifier (RNTI),
wherein the specific RNTI satisfies at least one of:
the specific RNTI is pre-defined;
the specific RNTI is configured with one or more RNTI values;
a range of an RNTI value of the specific RNTI is from a value FFF3 to a value FFFB;
the specific RNTI is an SI-RNTI; or
the specific RNTI is associated with a cell ID or cell indicator,
wherein one specific RNTI associates with one or more second cells.

18. (canceled)

19. The wireless communication method of claim 1, wherein DCI scheduling an SI for the second cell is a DCI format 1_0 with a CRC scrambled by a System Information RNTI, SI-RNTI, wherein a bit field in the DCI is used to indicate a target cell of the SI scheduled for.

20-38. (canceled)

39. A wireless communication device, comprising:
a communication unit; and
a processor configured to: receive, via the communication unit, a first signaling on a first cell from a wireless communication node or transmit, via the communication unit, to a wireless communication terminal, a first signaling on a first cell, wherein the first signaling comprises system configuration information for a second cell, and wherein the system configuration information comprises system information (SI) or random access information.

40-43. (canceled)

44. A non-transitory computer-readable storage medium storing instructions that, when executed by one or more processors, cause the one or more processors to perform:
receiving a first signaling on a first cell from a wireless communication node, or transmitting, to a wireless communication terminal, a first signaling on a first cell;
wherein the first signaling comprises system configuration information for a second cell, and wherein the system configuration information comprises system information (SI) or random access information.
